(19) United States
(12) Patent Application Publication
(10) Pub. No.: US 2021/0209555 A1
(43) Pub. Date: Jul. 8, 2021

(54) COLLABORATION-BASED APPLICATION CONFIGURATION SYSTEM

(71) Applicant: Microsoft Technology Licensing, LLC, Redmond, WA (US)

(72) Inventors: Sanjay Hemmige Ramaswamy, Redmond, WA (US); Patri Venkata Raghu Chandra Subhash, Bangalore (IN); Siddarth Rajendra Kumar, Bengaluru (IN); Bhavatarini Mallikarjuna Pushpa, Bangalore (IN); V. S. Srujana Oruganti, Bangalore (IN); Prasanth Sri Kara, Bangalore (IN); Sreeram Nivarthi, Redmond, WA (US); Abhishek Kalai Raghavendra, Bangalore (IN); Jagadeesh Virupaksha Huliyar, Redmond, WA (US); Tapas Bansal, Bangalore (IN); Amit Ramakant Patil, Bangalore (IN); Rajat Aggarwal, New Delhi (IN)

(21) Appl. No.: 16/734,707

(22) Filed: Jan. 6, 2020

(51) Int. Cl. G06Q 10/10; G06Q 10/06; G06F 9/445

(52) U.S. Cl. CPC G06Q 10/103; G06F 9/4451; G06Q 10/063114; G06Q 10/06393

(57) ABSTRACT

A system and method for determining collaboration metrics of an application is described. The system accesses user activity data of an application from a plurality of user accounts of an enterprise. Collaboration metrics for each user account are identified based on the corresponding user activity data. The system identifies a first group and a second group of user accounts from the plurality of user accounts. The system generates a recommendation of a configuration setting of the application for the second group of user accounts. A graphical user interface (GUI) indicates the first group and the second group of user accounts, and the recommendation of the configuration setting of the application for the second group of user accounts.

### BACKGROUND

The subject matter disclosed herein generally relates to a special-purpose machine that computes enterprise user collaboration metrics, including computerized variants of such special-purpose machines and improvements to such variants. Specifically, the present disclosure addresses systems and methods for measuring collaboration of user accounts based on user collaboration metrics.

Accessing metrics related to a performance of users of an enterprise can be difficult to determine given the millions of data point entries and the lack of context of computed metrics. Furthermore, the effectiveness and accuracy of human-driven analysis of large sets of data is increasingly low compared to machine-driven analysis. For example, if an organization needs a time sensitive analysis of a data set that has millions of entries across hundreds of variables, no human could perform such an analysis by hand or mentally. Furthermore, any such analysis may be out-of-date almost immediately, should an update be required.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating an enterprise collaboration engine in accordance with one example embodiment.

FIG. 3 illustrates a collaboration computation process in accordance with one example embodiment.

FIG. 4 illustrates a collaboration computation process in accordance with one example embodiment.

FIG. 5 illustrates a collaboration computation process in accordance with one example embodiment.

FIG. 6 illustrates a collaboration computation process in accordance with one example embodiment.

FIG. 7 is a flow diagram illustrating a method for generating a graphical user interface based on the collaboration report in accordance with one example embodiment.

FIG. 8 is a flow diagram illustrating a method for configuring a configuration setting of an enterprise application in accordance with one example embodiment.

FIG. 9 is a flow diagram illustrating a method for configuring a configuration setting of an enterprise application in accordance with another example embodiment.

FIG. 10 is a flow diagram illustrating a method for configuring a configuration setting of an enterprise application relative to a baseline in accordance with one example embodiment.

FIG. 11 is a flow diagram illustrating a method for configuring a configuration setting of an enterprise application relative to a benchmark in accordance with one example embodiment.

FIG. 12 illustrates a routine in accordance with one embodiment.

FIG. 13 illustrates an example graphical user interface in accordance with one embodiment.

FIG. 14 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present application describes a system for determining characteristics of users of an enterprise application with metrics and using the metrics to form a baseline for a group of users. In another example embodiment, the system generates a recommendation for a configuration setting of enterprise applications for each user account based on the team's conditioning plan.

Traditional analysis of characteristics of users relies on the availability of an outcome metric. An outcome metric is an attribute that is provided an administrator and manually uploaded to an organization data system. Typical examples of outcome metrics range from performance rating in one example to sales quotas in another example. Administrators can examine the characteristics of top performers (e.g., users of the enterprise application with top outcome metrics) and the rest of the group (e.g., other enterprise application users from the same or different enterprise). However, several problems exist with this approach:
Outcome metrics are not easily obtained because of legal and privacy hurdles.
When outcome metrics are loaded in the system, customers (usually analysts/consultants) have to juggle between multiple interfaces to perform any analysis.
Based on the offline analysis, any adjustments/conditioning that customers make is again outside of the system, and not based on real-time analytics.

The present application describes an example of identifying top performers in an organization based on collaboration metrics, such as collaboration hours, network size, and centrality. The present system further allows for the flexibility to incorporate additional external metrics (e.g., metrics from data external to the enterprise system) to identify top performers. Alternative embodiments to identify top performers include using correlation analysis and machine learning. The present system provides a tool to discover traits of top performers and apply characteristics of those traits to other users via recommendation of enterprise application configuration settings.

In one example embodiment, the present application describes a method for computing a performance of users in an enterprise. An enterprise represents organizations or groups of users associated with an organization. In particular, the system provides algorithms to calculate and identify metrics of top performing users relative to the performance metrics of peer users. The system identifies peer users based on a profile of a user (e.g., user in part of an accounting team in the enterprise). The system further renders a graph that displays different aspects of the performance of the top performing users relative to the same aspects of the performance of peers of the top performing user. The system computes the performance of a user based on collaboration metrics corresponding to the top performing users. The system accesses data points from an enterprise application operated by the enterprise. For example, devices associated with the enterprise communicate with a remote server hosting the enterprise application. In other examples, the devices associated with the enterprise include a local copy of the enterprise application and communicate user activities of local copy to the remote server. The data points include user activities associated with the enterprise application of the enterprise. Examples of data points include dates and times of users operating the enterprise application, types of documents being accessed or shared by users of the enterprise application, users calendar data from the enterprise application, communication data between users of the enterprise application, and enterprise organization data. Examples of enterprise applications include email applications, document editing applications, document sharing applications, and other types of applications used by enterprises.

In another example embodiment, a system and method for determining collaboration metrics of an enterprise application is described. The system accesses user activity data of an enterprise application from a plurality of user accounts of an enterprise. Collaboration metrics for each user account are identified based on the corresponding user activity data. The system identifies a first group and a second group of user accounts from the plurality of user accounts. The system generates a recommendation of a configuration setting of the enterprise application for the second group of user accounts. A graphical user interface (GUI) indicates the first group and the second group of user accounts, and the recommendation of the configuration setting of the enterprise application for the second group of user accounts.

As a result, one or more of the methodologies described herein facilitate solving the technical problem of dynamically identifying user accounts using collaboration metrics of an enterprise application and configuring each user application based on the collaboration metrics. The automatic configuration of the user applications based on the metrics improves the performance of the computing device of the user to enable the computing device to operate efficiently (e.g., less manually configuration and less idle resources being used). As such, one or more of the methodologies described herein may obviate a need for certain efforts or computing resources. Examples of such computing resources include processor cycles, network traffic, memory usage, data storage capacity, power consumption, network bandwidth, and cooling capacity.

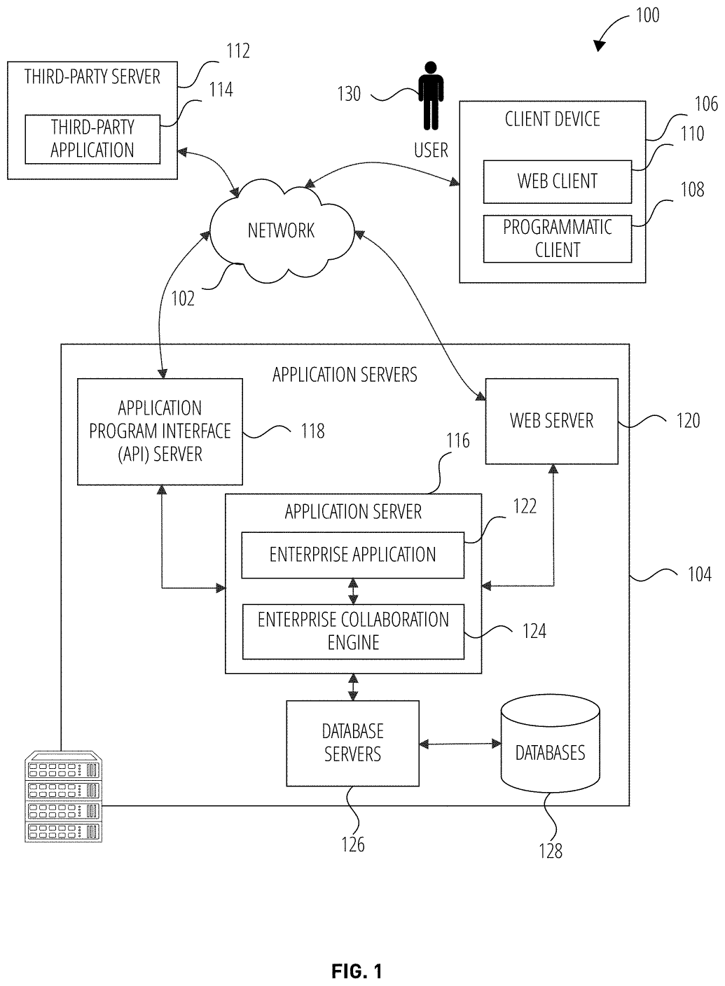

FIG. 1 is a diagrammatic representation of a network environment 100 in which some example embodiments of the present disclosure may be implemented or deployed. One or more application servers 104 provide server-side functionality via a network 102 to a networked user device, in the form of a client device 106. A user 130 operates the client device 106. The client device 106 includes a web client 110 (e.g., a browser), a programmatic client 108 (e.g., an email/calendar application such as Microsoft Outlook™, an instant message application, a document writing application, a shared document storage application) that is hosted and executed on the client device 106. In one example embodiment, the programmatic client 108 logs interaction data from the web client 110 and the programmatic client 108 with the enterprise application 122. In another example embodiment, the enterprise application 122 logs interaction data between the web client 110, the programmatic client 108, and the enterprise application 122. The interaction data may include for example, communication logs of communications (e.g., emails) between users of an enterprise or communications between users of the enterprise and outside users of the enterprise. Other examples of interaction data include and are not limited to email communications, meeting communications, instant messages, shared document comments, and any communication with a recipient (e.g., a user from or outside the enterprise).

An Application Program Interface (API) server 118 and a web server 120 provide respective programmatic and web interfaces to application servers 104. A specific application server 116 hosts the enterprise application 122 and an enterprise collaboration engine 124. Both enterprise application 122 and enterprise collaboration engine 124 include components, modules and/or applications.

The enterprise application 122 may include collaborative applications (e.g., a server side email/calendar enterprise application, a server side instant message enterprise application, a document writing enterprise application, a shared document storage enterprise application) that enable users of an enterprise to collaborate and share document, messages, and other data (e.g., meeting information, common projects) with each other. For example, the user 130 at the client device 106 may access the enterprise application 122 to edit documents that are shared with other users of the same enterprise. In another example, the client device 106 accesses the enterprise application 122 to retrieve or send messages or emails to and from other peer users of the enterprise. Other examples of enterprise application 122 includes enterprise systems, content management systems, and knowledge management systems.

In one example embodiment, the enterprise collaboration engine 124 communicates with the enterprise application 122 and accesses interaction data from users of the enterprise application 122. In another example embodiment, the enterprise collaboration engine 124 communicates with the programmatic client 108 and accesses interaction data from the user 130 with other users of the enterprise. In one example, the web client 110 communicates with the enterprise collaboration engine 124 and enterprise application 122 via the programmatic interface provided by the Application Program Interface (API) server 118.

The enterprise collaboration engine 124 computes user performance based on collaboration metrics collected from the interaction data collected by the enterprise application 122, the item web client 110, or the programmatic client 108. The collaboration metrics may be associated with a profile of the user (e.g., user demographic data, user enterprise related data, user enterprise application data). In one example, the enterprise collaboration engine 124 identifies top performers and non-top performers based on the collaboration metrics. In another example, the enterprise collaboration engine 124 compares the collaboration metrics of a user with a benchmark or a collaboration threshold to identify top performers.

In one example, the collaboration threshold is based on collaboration metrics of top collaborators of the same enterprise. The collaboration metrics of top collaborators may be determined based on predetermined thresholds and adjusted until a predetermined percentage of users are in the top performer category. In another example, the collaboration threshold is based on an enterprise application-specific predefined collaboration metrics. In another example, the collaboration threshold is based on collaboration metrics across an enterprise application used across different enterprises. In another example, the collaboration threshold is based on collaboration metrics across different enterprise applications used across a single enterprise.

The enterprise collaboration engine 124 generates a baseline (e.g., an average) for collaboration metrics based on the collaboration metrics of the top performers. In another example, the enterprise collaboration engine 124 generates a baseline for top performers in a group of users of the enterprise based on the collaboration metrics of the top performers in the group of the users. The enterprise collaboration engine 124 generates a recommendation for the non-top performers based on their collaboration metrics relative to the top performers. The recommendation includes a configuration setting of the enterprise application 122, the web client 110, or the programmatic client 108 to increase and foster collaboration metrics of the user 130.

The enterprise collaboration engine 124 generates a graphical user interface (GUI) that presents the baseline of the top performers relative to the collaboration metrics of the non-top performers. The GUI includes graphs that illustrate the relationship between a team-specific baseline, an enterprise-specific baseline, an enterprise application-specific baseline, an industry-wide baseline, and the collaboration metrics of top performers and non-top performers of the enterprise. In another example embodiment, the GUI indicates a recommendation based on the user collaboration metrics relative to one of the baselines. The GUI includes a user interactive region that includes one or more recommendations.

In another example embodiment, the enterprise collaboration engine 124 detects a selection of a recommended action from the recommendation and generates a dialog box pre-populated with information based on the recommended action (e.g., pre-filled with parameters of a feature of the enterprise application 122). The user 130 only has to click on one button to configure the programmatic client 108 with the new parameters. For example, the pre-filled parameters configure the programmatic client 108 to automatically generate (e.g., every Monday morning) a template email pre-addressed to other peer users (e.g., teammates working on a same project) with a pre-filled status on summary user activities related to the project. Such configuration results in a change of the collaboration metrics of the user 130 of the enterprise application 122. In another example, the configuration results in a change of the collaboration metrics of the enterprise application 122 of the peer users of the enterprise.

The application server 116 is shown to be communicatively coupled to database servers 126 that facilitates access to an information storage repository or databases 128. In an example embodiment, the databases 128 includes storage devices that store information (e.g., collaboration metrics) to be processed by the enterprise application 122 and the enterprise collaboration engine 124.

Additionally, a third-party application 114 may, for example, store another part of the enterprise application 122, or include a cloud storage system. For example, the third-party application 114 stores other metrics related to the other enterprises. The metrics may include size of the other enterprises, collaboration activity data from other industries, and industry benchmarks for collaboration metrics. The third-party application 114 executing on a third-party server 112, is shown as having programmatic access to the application server 116 via the programmatic interface provided by the Application Program Interface (API) server 118. For example, the third-party application 114, using information retrieved from the application server 116, may supports one or more features or functions on a web site hosted by the third party.

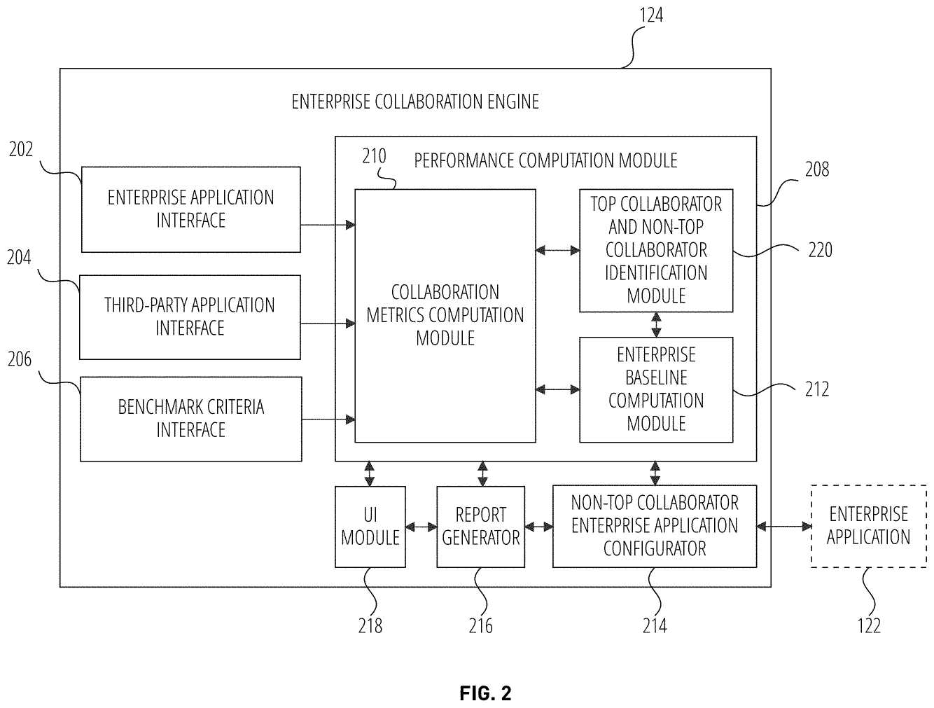

FIG. 2 is a block diagram illustrating an enterprise performance engine in accordance with one example embodiment. The enterprise collaboration engine 124 comprises an enterprise application interface 202, a third-party application interface 204, a benchmark criteria interface 206, a performance computation module 208, a non-top collaborator enterprise application configurator 214, a report generator 216, and a UI module 218.

The enterprise application interface 202 communicates with devices of all enterprises user accounts having access to the enterprise application 122. In one example embodiment, the enterprise application interface 202 accesses user interaction data from devices of enterprise users having access to the enterprise application 122. In one example, the user interaction data includes any interaction between any user account of the enterprise with the enterprise application 122. The user interaction data include collaboration metrics that identifies, for example, collaborations between users of the enterprise, or collaborations between users of the enterprise application 122 with other users (from the same enterprise) of the enterprise application 122. In another example embodiment, the enterprise application interface 202 accesses user interaction data from the enterprise application 122.

The third-party application interface 204 communicates with a third party database (e.g., third-party server 112) that stores periodically updated user interaction data of users with other enterprise applications (e.g., third-party application 114). In one example embodiment, the third-party application interface 204 retrieves the periodically updated user interaction data from the third-party server 112.

The benchmark criteria interface 206 retrieves a predefined collaboration metrics threshold or benchmark for the enterprise application 122 corresponding to a particular enterprise, other enterprise's applications for a particular enterprise, industry-wide metrics for all enterprise applications. For example, the benchmark criteria interface 206 retrieves preset benchmark threshold A for application A of enterprise A, preset benchmark threshold B for enterprise B for application B of enterprise A, preset benchmark threshold C for application A for a group of enterprises belonging to a group (e.g., an industry). In another example, the benchmark criteria interface 206 retrieves a collaboration benchmark from the enterprise application 122, the client device 106 of the enterprise, or from the third-party application 114.

The performance computation module 208 identifies top collaborators, a baseline for the top collaborators, and a recommendation for the non-top collaborators. In one example embodiment, the performance computation module 208 comprises a collaboration metrics computation module 210, a top collaborator and non-top collaborator identification module 220, and an enterprise baseline computation module 212.

The collaboration metrics computation module 210 communicates with enterprise application interface 202, third-party application interface 204, and benchmark criteria interface 206. The collaboration metrics computation module 210 retrieves user interaction data from enterprise application interface 202 and third-party application interface 204 and a predefined threshold from benchmark criteria interface 206.

The collaboration metrics computation module 210 computes collaboration metrics based on the user interaction data. Examples of collaboration metrics identified by the collaboration metrics computation module 210: Internal (e.g., within the enterprise) social network size, External (e.g., outside the enterprise) social network size, Internal collaboration hours as a percentage of total collaboration hours (collaboration hours−collaboration hours external/collaboration hours), External collaboration hours as a percentage of total collaboration hours ((collaboration hours external/collaboration hours)×100), Time with leadership as a percentage of total collaboration hours (((meeting hours with skip level+meeting hours with levels above skip level)/(after hours meeting hours+time in meetings during working hours))×100), Workweek span, Internal network breadth (networking outside organization), Manager's internal network size (internal network size of manager), Manager's external network size (external network size of manager), Manager's collaboration hours (collaboration hours of manager), Manager's time with leadership (manager's meeting hours with skip level+Manager's Meeting hours with levels above skip level), Percentage of collaboration hours from meetings ((meeting hours/collaboration hours)×100), Percentage of generated workload meeting hours from generated meetings ([Generated workload meeting hours/(Generated workload email hours+Generated workload meeting hours)] *100), Percentage of meeting hours with direct manager coattending ([Meeting hours with manager/Meeting hours] *100), 1:1 meeting hours with direct manager, Percentage of meeting hours with skip-level manager ([Meeting hours with skip level/Meeting hours] *100), Percentage of network from external relationships ([External network size/(Internal network size+External network size)] *100), Centrality (Centrality indicates how well connected a person is; top performers with high centrality values can be more influential and play a strategic role), Manager's centrality (Centrality indicates how well connected a person is; managers with high centrality are better able to connect their direct reports with opportunities across the organization, because they are connected to other employees with large networks), Betweenness centrality (Betweenness indicates the bridging potential that a person has to connect disconnected groups; top performers with high betweenness values might be the first to know about new information, are likely able to leverage early access to their benefit, and are well-positioned to be innovators), In-degree centrality (In-degree centrality indicates how sought after a person is; top performers with high in-degree centrality values are good role-models for their peers, but can also be overloaded if they are inundated with requests for information), Strong tie connections (Strong-tie connections indicate how active and frequent the relationships of a person are; top performers with high strong tie connections are generally well engaged with their network and have reliable access to their connections, enabling them to stay up to date and well informed to their benefit), Weak tie connections (Weak-tie connections indicate how rich the relationships of a person are; top performers with high weak-tie connections are generally exposed to much more diverse and fresh ideas to capitalize on), and Boundary spanning tie connections (Boundary-spanning tie connections indicates how diverse the relationships of a person are; top performers with high boundary-spanning tie connections are uniquely positioned to consume diverse information across levels, disciplines, and organizational boundaries, and leverage this to their benefit).

The top collaborator and non-top collaborator identification module 220 identifies the top collaborating users and non-top collaborating users from a group of users of an enterprise using a statistical analysis (e.g., top 10% users with the highest combination of collaboration metrics). In another example, the top collaborator and non-top collaborator identification module 220 identifies the top collaborating users and non-top collaborating users from a group of users of an enterprise based on a comparison of their corresponding collaborating metrics (determined by collaboration metrics computation module 210) relative to the collaboration threshold provided by the benchmark criteria interface 206.

The enterprise baseline computation module 212 computes a baseline for the top collaborating users from top collaborator and non-top collaborator identification module 220. For example, the enterprise baseline computation module 212 determines an average of internal collaboration hours as a percentage of total collaboration hours of the top collaborating users of an enterprise and an average external collaboration hours as a percentage of total collaboration hours of the top collaborating users of an enterprise. In another example, the enterprise baseline computation module 212 determines an average a combination of the collaboration metrics of the top collaborating users. In another example embodiment, the enterprise baseline computation module 212 communicates the baseline a group of users to the collaboration metrics computation module 210. The collaboration metrics computation module 210 and the top collaborator and non-top collaborator identification module 220 uses the baseline feedback from the enterprise baseline computation module 212 to further identify top collaborating users and non-top collaborating users.

The report generator 216 generates a report of top collaborating users and non-top collaborating users and identifies their relative collaboration metrics. In one example, the report generator 216 generates a graph that indicates the collaborating performance of a user of an enterprise relative to his/her peers as determined based on the profile of the user. For example, peers of the user may include other users in a same group of the enterprise (or other enterprises). In another example, the report generator 216 generates a graph that indicates collaboration metrics of the non-top collaborating users relative to the top collaborating users. In another example, the report generator 216 generates a graph that indicates collaboration metrics of users of the enterprise relative to users from other enterprises. In another example, the report generator 216 generates a graph that indicates collaboration metrics of users of a group of the enterprise relative to other users from other groups of enterprises.

The non-top collaborator enterprise application configurator 214 generates a recommendation based on the collaboration metrics of a user, a group of users, users of an enterprise relative to peer users, collaboration threshold, baseline, of other users from the same group of users, from other users of the enterprise, from users from other enterprises. For example, the non-top collaborator enterprise application configurator 214 provides one or more recommendations on how to increase the collaboration metrics of a user in the non-top collaborating group. In one example embodiment, the non-top collaborator enterprise application configurator 214 accesses a lookup table based on the relative collaboration metrics and identifies a recommended action based on a threshold margin between the collaboration metrics of a user (from the non-top collaborating group) and a baseline of the top collaborating group. The lookup table may specify different types of actions based on the value of the threshold margin.

In one example embodiment, the recommendation includes regularly emailing peers on the status of a project. The non-top collaborator enterprise application configurator 214 generates a configuration setting in the enterprise application 122 to automatically generate and send an email addressed to the peers on the status of the project. For example, if the user selects and accepts the recommendation suggested by the non-top collaborator enterprise application configurator 214, the non-top collaborator enterprise application configurator 214 configures the email application at the client device 106 of the user 130 with the suggested parameters (automatically emailing or adding peers of a project to a communication channel).

The UI module 218 generates a graphical user interface that displays the graphs showing the relative collaboration metrics from the collaboration metrics computation module 210, metrics from the top collaborating users from the top collaborator and non-top collaborator identification module 220, metrics from the non-top collaborating users from the top collaborator and non-top collaborator identification module 220, recommendation(s) from the non-top collaborator enterprise application configurator 214, and a GUI element for receiving a selection of the recommendation from the user 130. The UI module 218 also generates a GUI that displays a collaboration report from the report generator 216.

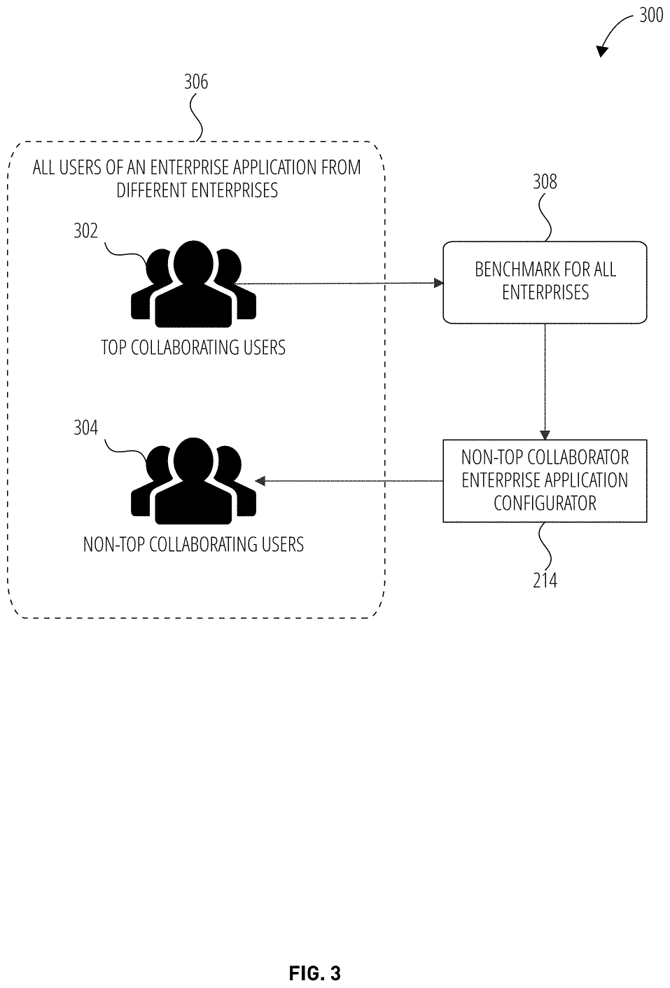

FIG. 3 illustrates a collaboration computation process 300 in accordance with one example embodiment. The collaboration metrics computation module 210 accesses collaboration metrics for all users of an enterprise application from different enterprises 306. The top collaborator and non-top collaborator identification module 220 identifies the top collaborating users 302 and the non-top collaborating users 304 based on the collaboration metrics. The enterprise baseline computation module 212 computes a benchmark for all enterprises 308 for the top collaborating users 302. The non-top collaborator enterprise application configurator 214 identifies the non-top collaborating users 304 based on the benchmark for all enterprises 308.

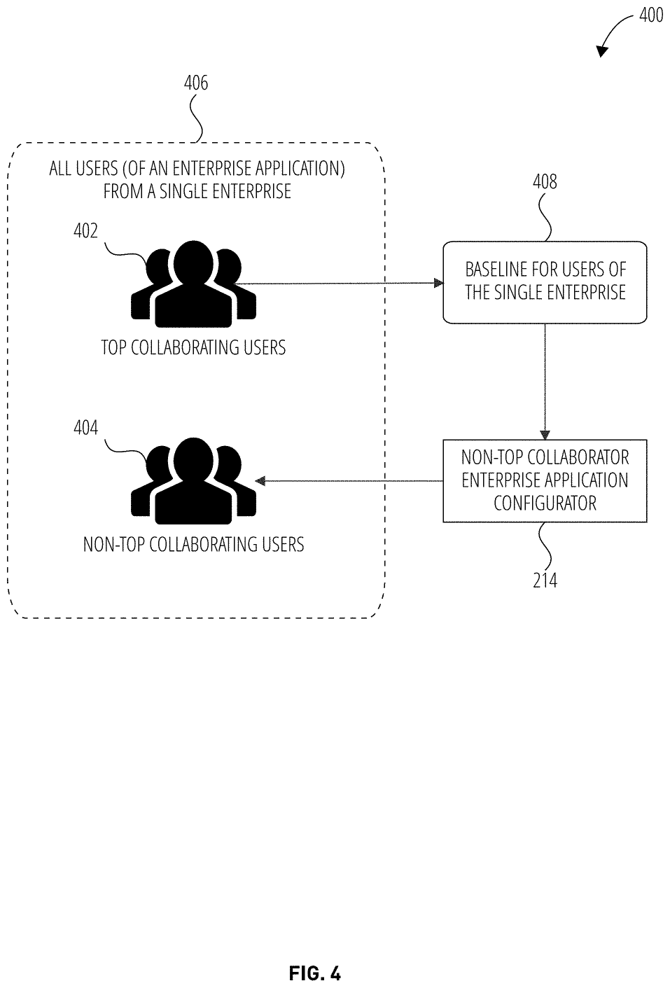

FIG. 4 illustrates a collaboration computation process 400 in accordance with one example embodiment. The collaboration metrics computation module 210 accesses collaboration metrics for all users (of an enterprise application) from a single enterprise 406. The top collaborator and non-top collaborator identification module 220 identifies the top collaborating users 402 and the non-top collaborating users 404 based on the collaboration metrics. For example, the top collaborator and non-top collaborator identification module 220 uses the collaboration metrics of each user and determines a threshold based on a statistical analysis (e.g., top collaborating users belong to a top 10 percentile). The enterprise baseline computation module 212 computes a baseline for users of the single enterprise 408 for the top collaborating users 402. The non-top collaborator enterprise application configurator 214 identifies the non-top collaborating users 404 based on the baseline for users of the single enterprise 408.

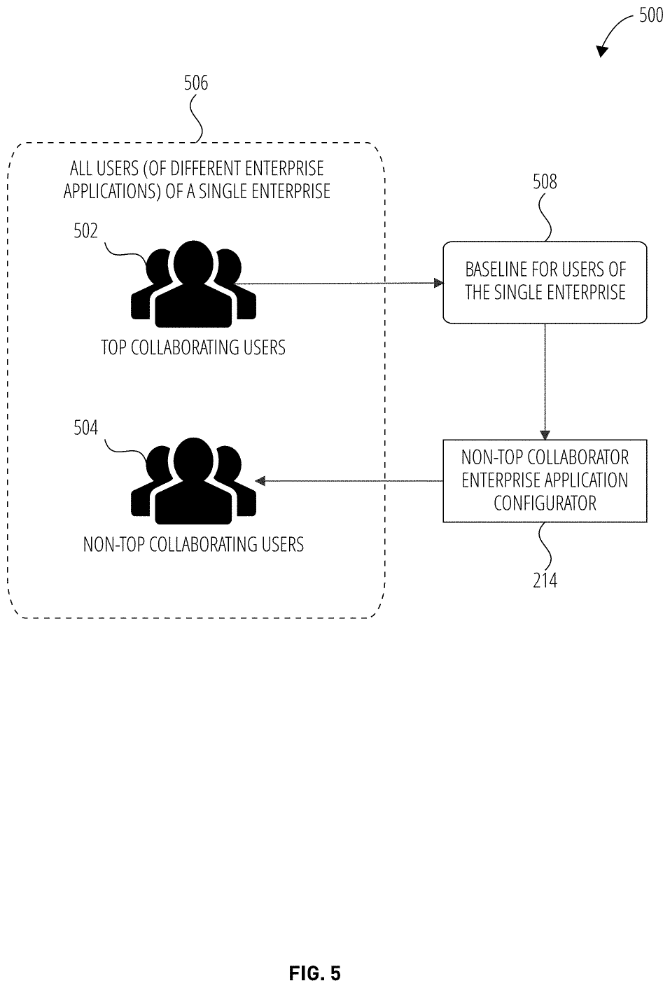

FIG. 5 illustrates a collaboration computation process 500 in accordance with one example embodiment. The collaboration metrics computation module 210 accesses collaboration metrics for all users (of different enterprise applications) of a single enterprise 506. The top collaborator and non-top collaborator identification module 220 identifies the top collaborating users 502 and the non-top collaborating users 504 based on the collaboration metrics. The enterprise baseline computation module 212 computes a baseline for users of the single enterprise 508 for the top collaborating users 502. The non-top collaborator enterprise application configurator 214 identifies the non-top collaborating users 504 based on the baseline for users of the single enterprise 508.

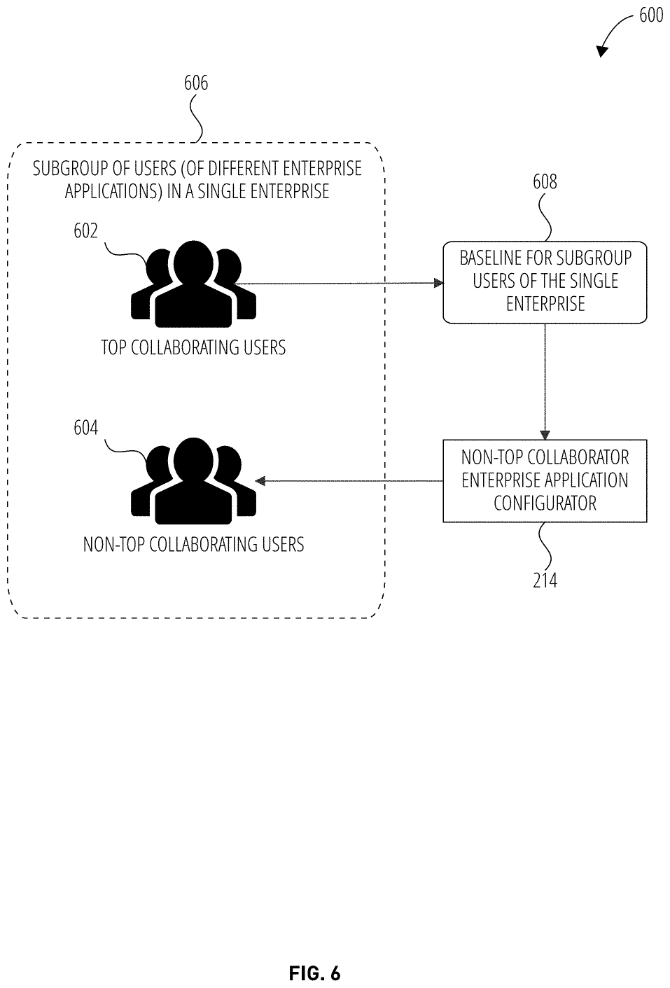

FIG. 6 illustrates a collaboration computation process 600 in accordance with one example embodiment. The collaboration metrics computation module 210 accesses collaboration metrics for subgroup of users (of different enterprise applications) in a single enterprise 606. The top collaborator and non-top collaborator identification module 220 identifies the top collaborating users 602 and the non-top collaborating users 604 based on the collaboration metrics. The enterprise baseline computation module 212 computes a baseline for subgroup users of the single enterprise 608 for the top collaborating users 602. The non-top collaborator enterprise application configurator 214 identifies the non-top collaborating users 604 based on the baseline for subgroup users of the single enterprise 608.

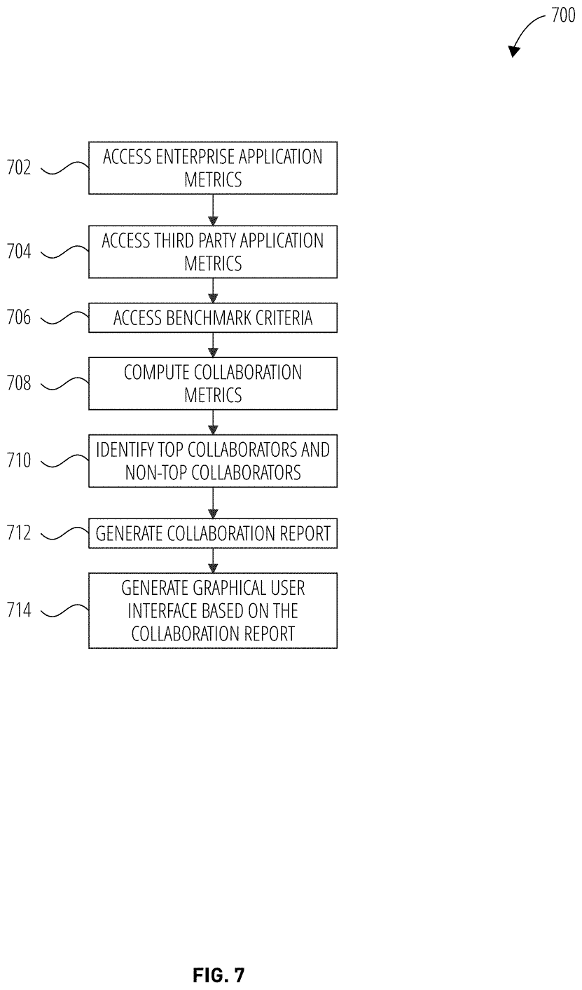

FIG. 7 is a flow diagram illustrating a method for generating a graphical user interface based on the collaboration report in accordance with one example embodiment. Operations in the method 700 may be performed by the enterprise collaboration engine 124, using components (e.g., modules, engines) described above with respect to FIG. 2. Accordingly, the method 700 is described by way of example with reference to the enterprise collaboration engine 124. However, it shall be appreciated that at least some of the operations of the method 700 may be deployed on various other hardware configurations or be performed by similar components residing elsewhere. For example, some of the operations may be performed at the client device 106.

At block 702, the enterprise application interface 202 accesses enterprise application metrics. At block 704, the third-party application interface 204 accesses third-party application metrics. At block 706, the performance computation module 208 accesses benchmark criteria (e.g., predefined collaboration metrics thresholds). At block 708, the collaboration metrics computation module 210 computes collaboration metrics based on the enterprise application metrics and the third-party application metrics. At block 710, the top collaborator and non-top collaborator identification module 220 identifies the top collaborating users and the non-top collaborating users. At block 712, report generator 216 generates a collaboration report based on the collaboration metrics. At block 714, the UI module 218 generates a GUI based on the collaboration report.

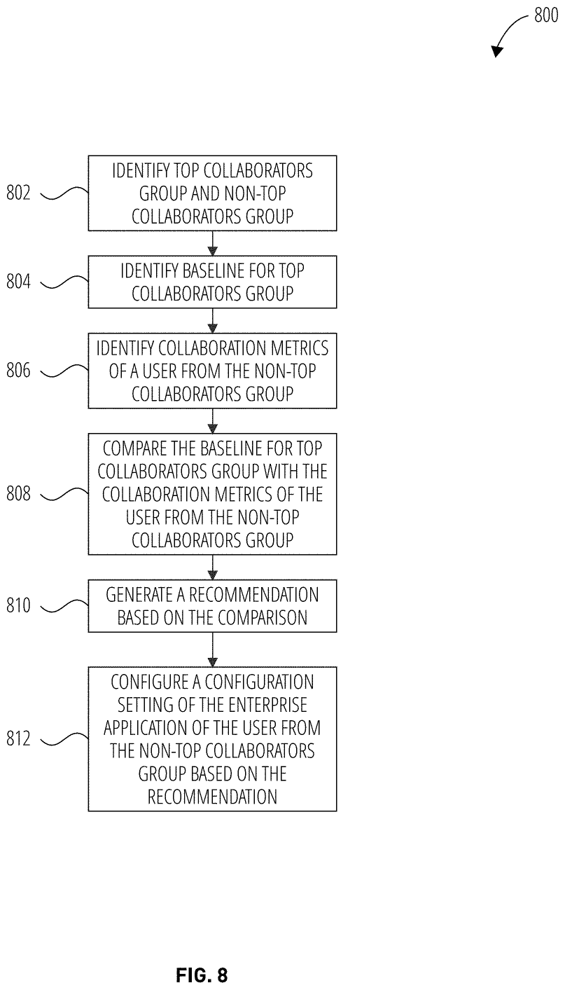

FIG. 8 is a flow diagram illustrating a method for configuring a configuration setting of an enterprise application in accordance with one example embodiment. Operations in the method 800 may be performed by the enterprise collaboration engine 124, using components (e.g., modules, engines) described above with respect to FIG. 2. Accordingly, the method 800 is described by way of example with reference to the enterprise collaboration engine 124. However, it shall be appreciated that at least some of the operations of the method 800 may be deployed on various other hardware configurations or be performed by similar components residing elsewhere. For example, some of the operations may be performed at the client device 106.

At block 802, the top collaborator and non-top collaborator identification module 220 identifies a top collaborators group and a non-top collaborators group. At block 804, the enterprise baseline computation module 212 identifies the baseline for the top collaborators group. At block 806, the non-top collaborator enterprise application configurator 214 identifies collaboration metrics of a user from the non-top collaborators group. At block 808, the non-top collaborator enterprise application configurator 214 compares the baseline of the top collaborators group with the collaboration metrics of the user from the non-top collaborators group. At block 810, the non-top collaborator enterprise application configurator 214 generates a recommendation based on the comparison of block 808. At block 812, the non-top collaborator enterprise application configurator 214 configures a configuration setting of the enterprise application 122 of the user from the non-top collaborators group.

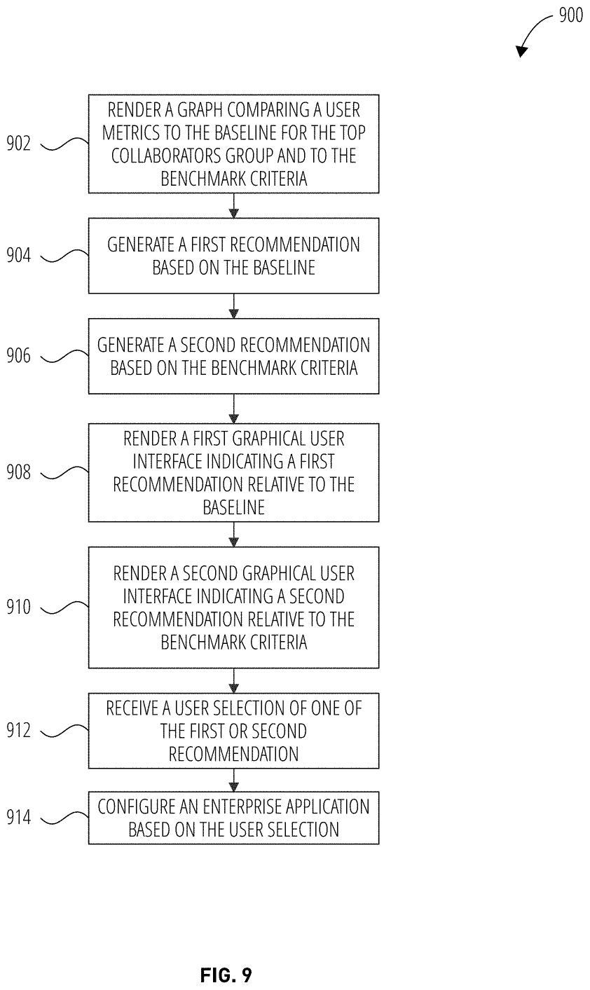

FIG. 9 is a flow diagram illustrating a method for configuring a configuration setting of an enterprise application in accordance with another example embodiment. Operations in the method 900 may be performed by the enterprise collaboration engine 124, using components (e.g., modules, engines) described above with respect to FIG. 2. Accordingly, the method 900 is described by way of example with reference to the enterprise collaboration engine 124. However, it shall be appreciated that at least some of the operations of the method 900 may be deployed on various other hardware configurations or be performed by similar components residing elsewhere. For example, some of the operations may be performed at the client device 106.

At block 902, the UI module 218 renders a graph that compares a user metrics to the baseline for the top collaborators group and to the benchmark criteria. At block 904, the non-top collaborator enterprise application configurator 214 generates a first recommendation based on the baseline. At block 906, the non-top collaborator enterprise application configurator 214 generates a second recommendation based on the benchmark criteria. At block 908, the UI module 218 renders a first GUI that indicates a first recommendation relative to the baseline. At block 910, the UI module 218 renders a second GUI that indicates a second recommendation relative to the benchmark criteria. At block 912, the UI module 218 receives a user selection of one of the first or second recommendation. At block 914, the non-top collaborator enterprise application configurator 214 configures the enterprise application 122 based on the user selection.

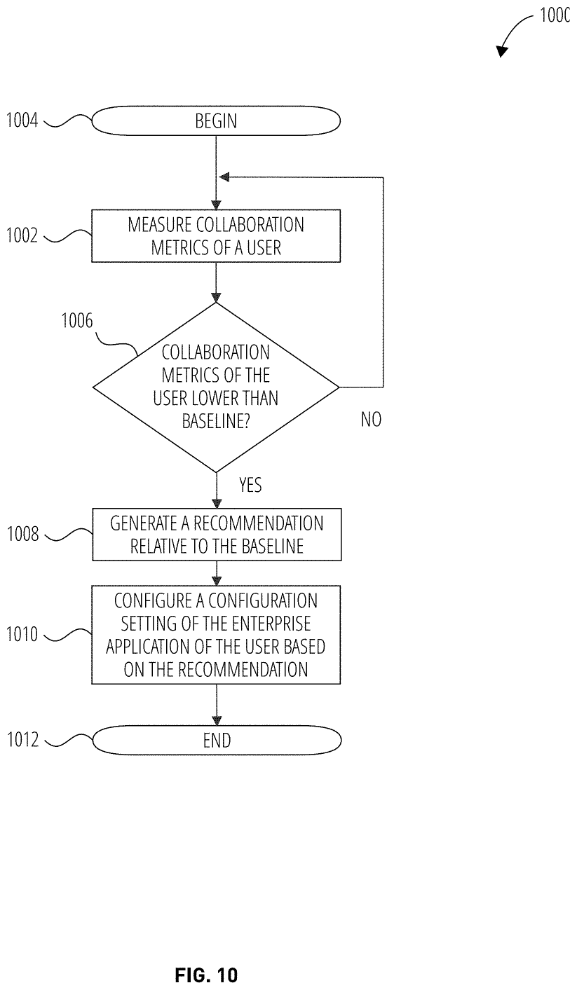

FIG. 10 is a flow diagram illustrating a method 1000 for configuring a configuration setting of an enterprise application relative to a baseline in accordance with one example embodiment. Operations in the method 1000 may be performed by the enterprise collaboration engine 124, using components (e.g., modules, engines) described above with respect to FIG. 2. Accordingly, the method 1000 is described by way of example with reference to the enterprise collaboration engine 124. However, it shall be appreciated that at least some of the operations of the method 1000 may be deployed on various other hardware configurations or be performed by similar components residing elsewhere. For example, some of the operations may be performed at the client device 106.

At block 1002, the collaboration metrics computation module 210 measures collaboration metrics of a user. At decision block 1006, the top collaborator and non-top collaborator identification module 220 determines whether the collaboration metrics of the user are lower than the baseline determined by the enterprise baseline computation module 212. If the collaboration metrics of the user are higher than the baseline determined by the enterprise baseline computation module 212, the process restarts at block 1004. If the collaboration metrics of the user are lower than the baseline determined by the enterprise baseline computation module 212, the non-top collaborator enterprise application configurator 214 generates a recommendation based the relative difference between the collaboration metrics and the baseline at block 1008. At block 1010, the non-top collaborator enterprise application configurator 214 configures a configuration setting of the enterprise application 122 based on the recommendation. The method 1000 ends at block 1012.

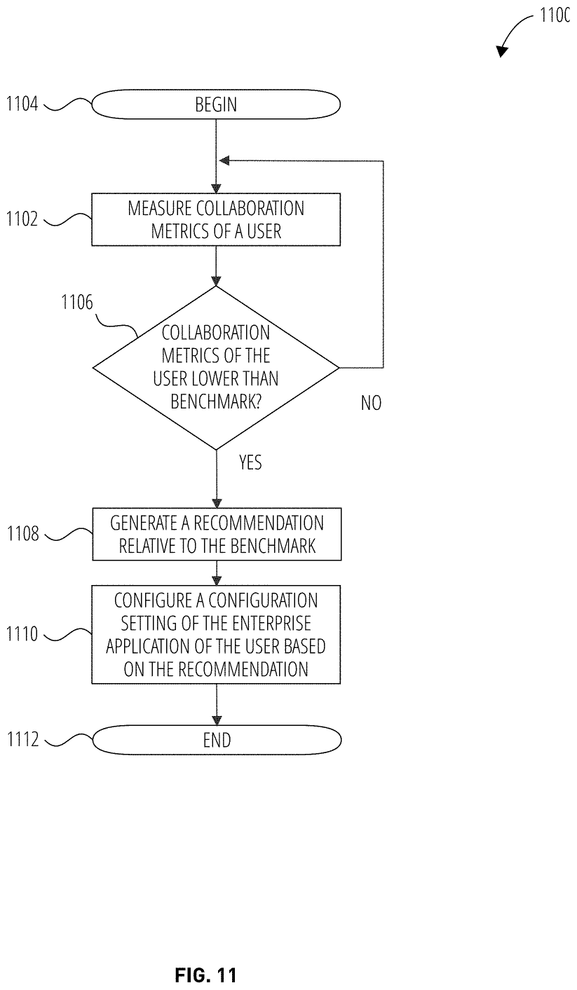

FIG. 11 is a flow diagram illustrating a method 1100 for configuring a configuration setting of an enterprise application relative to a benchmark in accordance with one example embodiment. Operations in the method 1100 may be performed by the enterprise collaboration engine 124, using components (e.g., modules, engines) described above with respect to FIG. 2. Accordingly, the method 1100 is described by way of example with reference to the enterprise collaboration engine 124. However, it shall be appreciated that at least some of the operations of the method 1100 may be deployed on various other hardware configurations or be performed by similar components residing elsewhere. For example, some of the operations may be performed at the client device 106.

At block 1102, the collaboration metrics computation module 210 measures collaboration metrics of a user. At decision block 1106, the top collaborator and non-top collaborator identification module 220 determines whether the collaboration metrics of the user are lower than the benchmark provided by the benchmark criteria interface 206. If the collaboration metrics of the user are higher than the benchmark, the process restarts at block 1104. If the collaboration metrics of the user are lower than the benchmark, the non-top collaborator enterprise application configurator 214 generates a recommendation based the relative difference between the collaboration metrics and the benchmark at block 1108. At block 1110, the non-top collaborator enterprise application configurator 214 configures a configuration setting of the enterprise application 122 based on the recommendation. The method 1100 ends at block 1112.

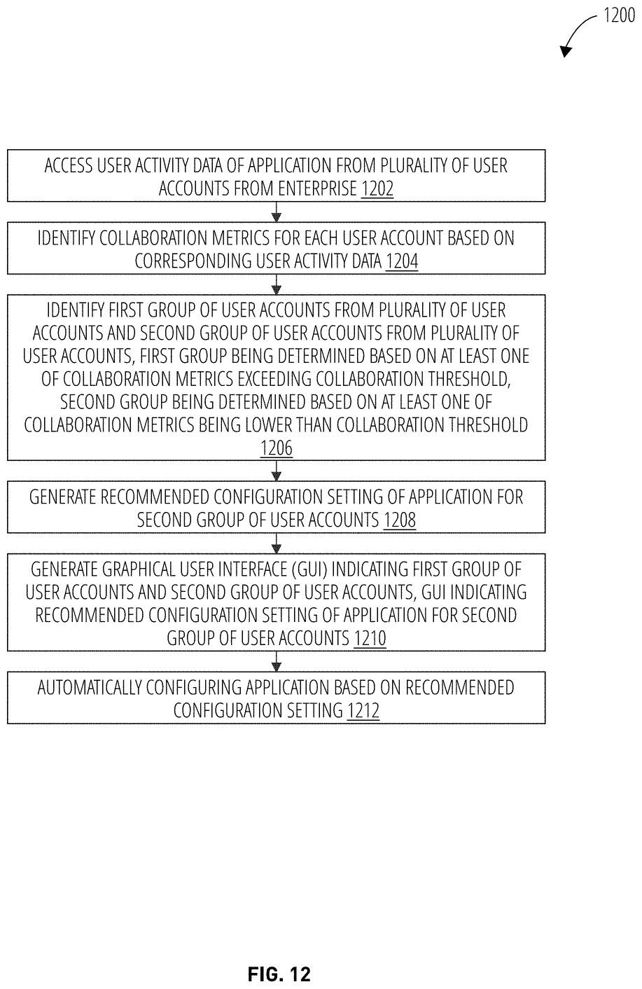

FIG. 12 illustrates a routine 1200 in accordance with one embodiment. In block 1202, routine 1200 accesses user activity data of an application from a plurality of user accounts from an enterprise. In block 1204, routine 1200 identifies collaboration metrics for each user account based on the corresponding user activity data. In block 1206, routine 1200 identifies a first group of user accounts from the plurality of user accounts and a second group of user accounts from the plurality of user accounts, the first group being determined based on at least one of the collaboration metrics exceeding a collaboration threshold, the second group being determined based on at least one of the collaboration metrics being lower than the collaboration threshold. In block 1208, routine 1200 generates a recommended configuration setting of the application for the second group of user accounts. In block 1210, routine 1200 generates a graphical user interface (GUI) indicating the first group of user accounts and the second group of user accounts, the GUI indicating the recommended configuration setting of the application for the second group of user accounts. In block 1212, routine 1200 automatically configuring the application based on the recommended configuration setting.

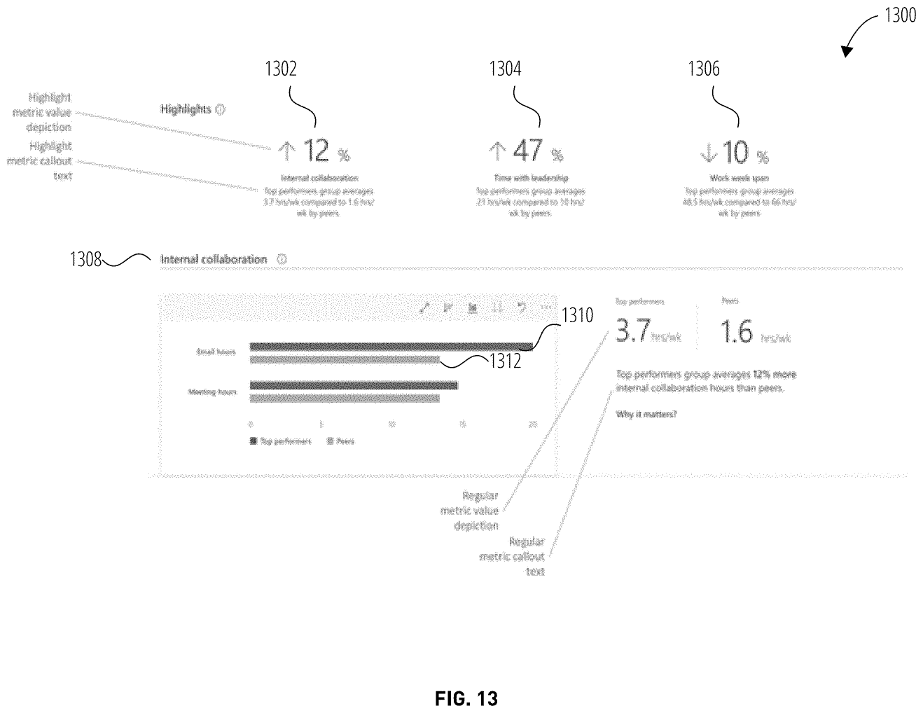

FIG. 13 illustrates an example GUI 1300 in accordance with one embodiment. The example GUI 1300 indicates an internal collaboration metric 1302, a time with leadership metric 1304, a work week span metric 1306, and an internal collaboration graph 1308. The internal collaboration graph 1308 indicates a graph representing top performers email hours 1310 relative to peers email hours 1312.

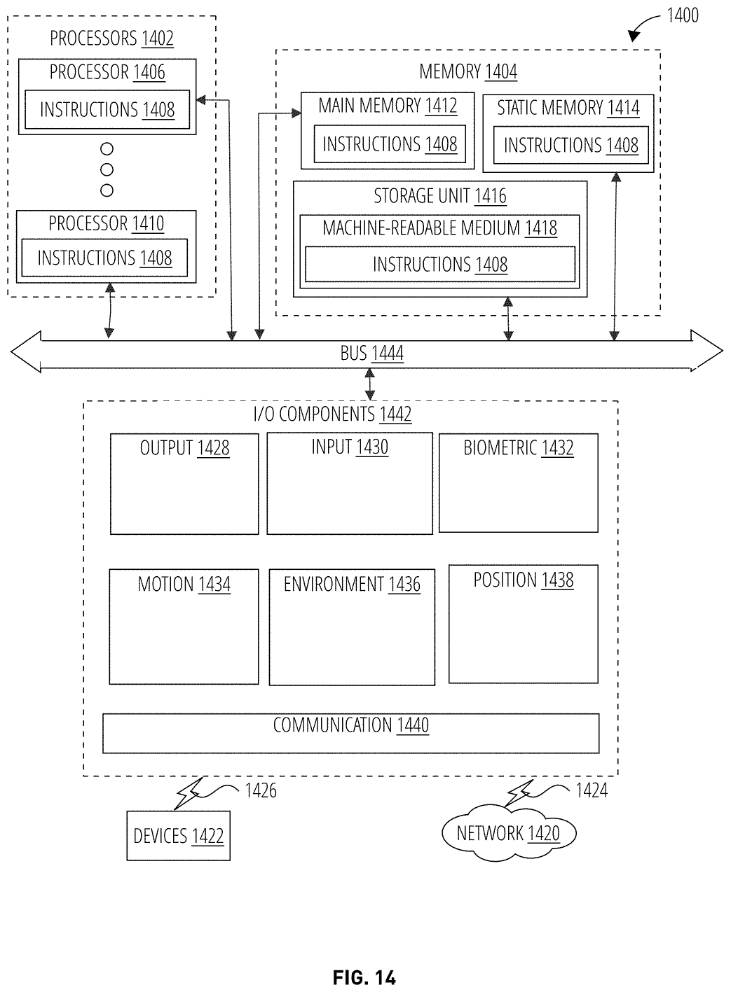

FIG. 14 is a diagrammatic representation of the machine 1400 within which instructions 1408 (e.g., software, a program, an application, an applet, an app, or other executable code) for causing the machine 1400 to perform any one or more of the methodologies discussed herein may be executed. For example, the instructions 1408 may cause the machine 1400 to execute any one or more of the methods described herein. The instructions 1408 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1408, sequentially or otherwise, that specify actions to be taken by the machine 1400. Further, while only a single machine 1400 is illustrated, the term “machine” shall also be taken to include a collection of machines that individually or jointly execute the instructions 1408 to perform any one or more of the methodologies discussed herein.

The machine 1400 may include processors 1402, memory 1404, and I/O components 1442, which may be configured to communicate with each other via a bus 1444. In an example embodiment, the processors 1402 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1406 and a processor 1410 that execute the instructions 1408. The term “processor” is intended to include multi-core processors that may comprise two or more independent processors (sometimes referred to as “cores”) that may execute instructions contemporaneously. Although FIG. 14 shows multiple processors 1402, the machine 1400 may include a single processor with a single core, a single processor with multiple cores (e.g., a multi-core processor), multiple processors with a single core, multiple processors with multiples cores, or any combination thereof.

The memory 1404 includes a main memory 1412, a static memory 1414, and a storage unit 1416, both accessible to the processors 1402 via the bus 1444. The main memory 1404, the static memory 1414, and storage unit 1416 store the instructions 1408 embodying any one or more of the methodologies or functions described herein. The instructions 1408 may also reside, completely or partially, within the main memory 1412, within the static memory 1414, within machine-readable medium 1418 within the storage unit 1416, within at least one of the processors 1402 (e.g., within the processor's cache memory), or any suitable combination thereof, during execution thereof by the machine 1400.

The I/O components 1442 may include a wide variety of components to receive input, provide output, produce output, transmit information, exchange information, capture measurements, and so on. The specific I/O components 1442 that are included in a particular machine will depend on the type of machine. For example, portable machines such as mobile phones may include a touch input device or other such input mechanisms, while a headless server machine will likely not include such a touch input device. It will be appreciated that the I/O components 1442 may include many other components that are not shown in FIG. 14. In various example embodiments, the I/O components 1442 may include output components 1428 and input components 1430. The output components 1428 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1430 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1442 may include biometric components 1432, motion components 1434, environmental components 1436, or position components 1438, among a wide array of other components. For example, the biometric components 1432 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1434 include acceleration sensor components (e.g., accelerometer), gravitation sensor components, rotation sensor components (e.g., gyroscope), and so forth. The environmental components 1436 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1438 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1442 further include communication components 1440 operable to couple the machine 1400 to a network 1420 or devices 1422 via a coupling 1424 and a coupling 1426, respectively. For example, the communication components 1440 may include a network interface component or another suitable device to interface with the network 1420. In further examples, the communication components 1440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1422 may be another machine or any of a wide variety of peripheral devices (e.g., a peripheral device coupled via a USB).

Moreover, the communication components 1440 may detect identifiers or include components operable to detect identifiers. For example, the communication components 1440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1440, such as location via Internet Protocol (IP) geolocation, location via Wi-Fi® signal triangulation, location via detecting an NFC beacon signal that may indicate a particular location, and so forth.

The various memories (e.g., main memory 1412, static memory 1414, and/or memory of the processors 1402) and/or storage unit 1416 may store one or more sets of instructions and data structures (e.g., software) embodying or used by any one or more of the methodologies or functions described herein. These instructions (e.g., the instructions 1408), when executed by processors 1402, cause various operations to implement the disclosed embodiments.

The instructions 1408 may be transmitted or received over the network 1420, using a transmission medium, via a network interface device (e.g., a network interface component included in the communication components 1440) and using any one of a number of well-known transfer protocols (e.g., hypertext transfer protocol (HTTP)). Similarly, the instructions 1408 may be transmitted or received using a transmission medium via the coupling 1426 (e.g., a peer-to-peer coupling) to the devices 1422.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### EXAMPLES

Example 1 is a computer-implemented method comprising: accessing user activity data of an enterprise application from a plurality of user accounts of an enterprise; identifying collaboration metrics for each user account based on the corresponding user activity data; identifying a first group of user accounts from the plurality of user accounts and a second group of user accounts from the plurality of user accounts, the first group being determined based on the collaboration metrics exceeding a collaboration threshold, the second group being determined based on the collaboration metrics being lower than the collaboration threshold; generating a recommendation of a configuration setting of the enterprise application for the second group of user accounts; and generating a graphical user interface (GUI) indicating the first group of user accounts and the second group of user accounts, the GUI indicating the recommendation of the configuration setting of the enterprise application for the second group of user accounts.

Example 2 is the computer-implemented method of example 1, further comprising: accessing third-party activity data of a third-party enterprise application from the plurality of user accounts of the enterprise; and computing the collaboration metrics based on the third-party activity data and the user activity data.

Example 3 is the computer-implemented method of any of the above examples, further comprising: identifying a baseline of the first group; and comparing collaboration metrics of a user account from the second group with the baseline, wherein the configuration setting of the enterprise application for the user account is based on the comparing the collaboration metrics of the user account from the second group with the baseline.

Example 4 is the computer-implemented method of any of the above examples, wherein the collaboration threshold comprises a multi-enterprise collaboration threshold from on a plurality of enterprises.

Example 5 is the computer-implemented method of any of the above examples, wherein the GUI further indicates the collaboration metrics of a user account from the second group relative to the collaboration metrics from the first group.

Example 6 is the computer-implemented method of any of the above examples, further comprising: generating a user recommendation of the configuration setting of the enterprise application for a user account of the second group; and configuring the enterprise application of the user account from the second group based on the configuration setting in the user recommendation

Example 7 is the computer-implemented method of any of the above examples, wherein the GUI comprises: a first graphical user interface element that compares the collaboration metrics of a user account from the second group with a baseline of the first group; and a second graphical user interface element that compares the collaboration metrics of the user account from the second group with the collaboration threshold that is based on a plurality of enterprises.

Example 8 is the computer-implemented method of any of the above examples, further comprising: generating a first recommendation based on the first graphical user interface element, the first recommendation comprising a first configuration setting of the enterprise application for the user account from the second group; and generating a second recommendation based on the second graphical user interface element, the second recommendation comprising a second configuration setting of the enterprise application for the user account from the second group.

Example 9 is the computer-implemented method of any of the above examples, further comprising: detecting a selection of the first or second recommendation from the user account of the second group; and configuring the enterprise application of the user account based on the selection

Example 10 is the computer-implemented method of any of the above examples, wherein the collaboration metrics comprise an internal network size, an external network size, internal collaboration hours as a percentage of total collaboration hours, external collaboration hours as a percentage of total collaboration hours, time with leadership as a percentage of total collaboration hours.

What is claimed is:

1. A computer-implemented method comprising:
accessing user activity data of an application from a plurality of user accounts from an enterprise;
identifying collaboration metrics for each user account based on the corresponding user activity data;
identifying a first group of user accounts from the plurality of user accounts and a second group of user accounts from the plurality of user accounts, the first group being determined based on at least one of the collaboration metrics exceeding a collaboration threshold, the second group being determined based on at least one of the collaboration metrics being lower than the collaboration threshold;
generating a recommended configuration setting of the application for the second group of user accounts;
generating a graphical user interface (GUI) indicating the first group of user accounts and the second group of user accounts, the GUI indicating the recommended configuration setting of the application for the second group of user accounts; and
automatically configuring the application based on the recommended configuration setting.

2. The computer-implemented method of claim 1, further comprising:
accessing third-party activity data of a third-party enterprise application from the plurality of user accounts of the enterprise; and
computing the collaboration metrics based on the third-party activity data and the user activity data.

3. The computer-implemented method of claim 1, further comprising:
identifying a baseline of the first group; and
comparing collaboration metrics of a user account from the second group with the baseline,
wherein the recommended configuration setting of the application for the user account is based on the comparing the collaboration metrics of the user account from the second group with the baseline.

4. The computer-implemented method of claim 1, wherein the collaboration threshold comprises a multi-enterprise collaboration threshold from a plurality of enterprises.

5. The computer-implemented method of claim 1, wherein the GUI further indicates the collaboration metrics of a user account from the second group relative to the collaboration metrics from the first group.

6. The computer-implemented method of claim 1, further comprising:
generating a user recommended configuration setting of the application for a user account of the second group; and
configuring the application of the user account from the second group based on the user recommended configuration setting.

7. The computer-implemented method of claim 1, wherein the GUI comprises:
a first graphical user interface element that compares the collaboration metrics of a user account from the second group with a baseline of the first group; and
a second graphical user interface element that compares the collaboration metrics of the user account from the second group with the collaboration threshold that is based on a plurality of enterprises.

8. The computer-implemented method of claim 7, further comprising:
generating a first recommendation based on the first graphical user interface element, the first recommendation comprising a first configuration setting of the application for the user account from the second group; and
generating a second recommendation based on the second graphical user interface element, the second recommendation comprising a second configuration setting of the application for the user account from the second group.

9. The computer-implemented method of claim 8, further comprising:
detecting a selection of the first or second recommendation from the user account of the second group; and
configuring the application of the user account based on the selection.

10. The computer-implemented method of claim 1, wherein the collaboration metrics comprise an internal network size, an external network size, internal collaboration hours as percentage of total collaboration hours, external collaboration hours as percentage of total collaboration hours, time with leadership as percentage of total collaboration hours.

11. A computing apparatus, the computing apparatus comprising:
a processor; and
a memory storing instructions that, when executed by the processor, configure the apparatus to:
access user activity data of an application from a plurality of user accounts from an enterprise;
identify collaboration metrics for each user account based on the corresponding user activity data;
identify a first group of user accounts from the plurality of user accounts and a second group of user accounts from the plurality of user accounts, the first group being determined based on at least one of the collaboration metrics exceeding a collaboration threshold, the second group being determined based on at least one of the collaboration metrics being lower than the collaboration threshold;
generate a recommended configuration setting of the application for the second group of user accounts;
generate a graphical user interface (GUI) indicating the first group of user accounts and the second group of user accounts, the GUI indicating the recommended configuration setting of the application for the second group of user accounts; and
automatically configure the application based on the recommended configuration setting.

12. The computing apparatus of claim 11, wherein the instructions further configure the apparatus to:
access third-party activity data of a third-party enterprise application from the plurality of user accounts of the enterprise; and
compute the collaboration metrics based on the third-party activity data and the user activity data.

13. The computing apparatus of claim 11, wherein the instructions further configure the apparatus to:
identify a baseline of the first group; and
compare collaboration metrics of a user account from the second group with the baseline,
wherein the recommended configuration setting of the application for the user account is based on the comparing the collaboration metrics of the user account from the second group with the baseline.

14. The computing apparatus of claim 11, wherein the collaboration threshold comprises a multi-enterprise collaboration threshold from a plurality of enterprises.

15. The computing apparatus of claim 11, wherein the GUI further indicates the collaboration metrics of a user account from the second group relative to the collaboration metrics from the first group.

16. The computing apparatus of claim 11, wherein the instructions further configure the apparatus to:
generate a user recommended configuration setting of the application for a user account of the second group; and
configure the application of the user account from the second group based on the user recommended configuration setting.

17. The computing apparatus of claim 11, wherein the GUI comprises:
a first graphical user interface element that compares the collaboration metrics of a user account from the second group with a baseline of the first group; and
a second graphical user interface element that compares the collaboration metrics of the user account from the second group with the collaboration threshold that is based on a plurality of enterprises.

18. The computing apparatus of claim 17, wherein the instructions further configure the apparatus to:
generate a first recommendation based on the first graphical user interface element, the first recommendation comprising a first configuration setting of the application for the user account from the second group; and
generate a second recommendation based on the second graphical user interface element, the second recommendation comprising a second configuration setting of the application for the user account from the second group.

19. The computing apparatus of claim 18, wherein the instructions further configure the apparatus to:
detect a selection of the first or second recommendation from the user account of the second group; and
configure the application of the user account based on the selection.

20. A non-transitory computer-readable storage medium, the computer-readable storage medium including instructions that when executed by a computer, cause the computer to:
access user activity data of an application from a plurality of user accounts from an enterprise;
identify collaboration metrics for each user account based on the corresponding user activity data;
identify a first group of user accounts from the plurality of user accounts and a second group of user accounts from the plurality of user accounts, the first group being determined based on at least one of the collaboration metrics exceeding a collaboration threshold, the second group being determined based on at least one of the collaboration metrics being lower than the collaboration threshold;
generate a recommended configuration setting of the application for the second group of user accounts;
generate a graphical user interface (GUI) indicating the first group of user accounts and the second group of user accounts, the GUI indicating the recommended configuration setting of the application for the second group of user accounts; and
automatically configure the application based on the recommended configuration setting.
